(19) United States
(12) Patent Application Publication
(10) Pub. No.: US 2024/0333602 A1
(43) Pub. Date: Oct. 3, 2024

(54) DECENTRALIZED ACTIVE-LEARNING MODEL UPDATE AND BROADCAST MECHANISM IN INTERNET-OF-THINGS ENVIRONMENT

(71) Applicant: Intel Corporation, Santa Clara, CA (US)

(72) Inventors: Hai Tao WANG, Shanghai (CN); Yong LI, Shanghai (CN); Kailun QIN, Shanghai (CN); Chengye LI, Shanghai (CN)

(73) Assignee: Intel Corporation, Santa Clara, CA (US)

(21) Appl. No.: 18/574,793

(22) PCT Filed: Dec. 7, 2021
(86) PCT No.: PCT/CN2021/135987

§ 371 Date: Dec. 28, 2023

(51) Int. Cl. H04L 41/16; G06N 3/091; G16Y 20/20; G16Y 40/35; G16Y 40/40

(52) U.S. Cl. CPC H04L 41/16; G06N 3/091; G16Y 20/20; G16Y 40/35; G16Y 40/40

(57) ABSTRACT

Systems, apparatuses and methods include technology that identifies a model update that originates from a plurality of IoT devices. The technology determines votes from the plurality of IoT devices, where the votes indicate whether the model update will be deployed. The technology deploys the model update to the plurality of IoT devices based on the votes.

### TECHNICAL FIELD

Embodiments generally relate to a decentralized model to determine updates and provide updates to internet-of-things (IoT) devices. More particularly, embodiments implement a real-time update system based on model optimization of abnormal events and verification mechanism in industrial IoT environments to improve the scalability of artificial intelligence (AI) edge elastic inference.

### BACKGROUND

IoT environments may include numerous different devices that operate together. In such environments, errors may arise which are difficult to address at a system wide level. For example, while a model update may cure a deficiency for one IoT device, the model update may generate new errors for other IoT devices. Thus, identifying model updates that are effective may be problematic, consume excessive computing resources and generate unpredicted errors.

### BRIEF DESCRIPTION OF THE DRAWINGS

The various advantages of the embodiments will become apparent to one skilled in the art by reading the following specification and appended claims, and by referencing the following drawings, in which:

FIG. 1 is a diagram of an example of a decentralized active-learning model update and broadcast architecture according to an embodiment;

FIG. 2 is a flowchart of an example of a method to generate and deploy a model update according to an embodiment;

FIG. 3 is a flowchart of an example of a method to implement a model update according to an embodiment;

FIG. 4 is a diagram of an example of an architecture for model updates according to an embodiment;

FIG. 5 is a diagram of an example of publication subscription system according to an embodiment;

FIG. 6 is a diagram of an example of a distributed update architecture according to an embodiment;

FIG. 7 is a block diagram of an example of a performance enhanced computing system according to an embodiment;

FIG. 8 is an illustration of an example of a semiconductor apparatus according to an embodiment;

FIG. 9 is a block diagram of an example of a processor according to an embodiment; and

FIG. 10 is a block diagram of an example of a multi-processor based computing system according to an embodiment.

### DESCRIPTION OF EMBODIMENTS

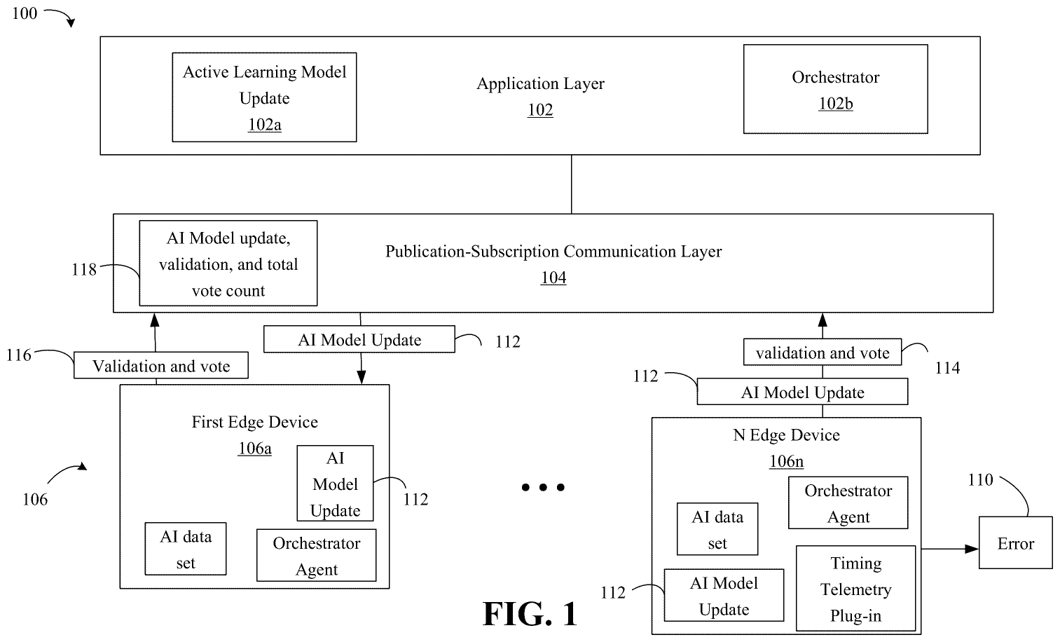

FIG. 1 illustrates a decentralized active-learning model update and broadcast architecture 100. The decentralized active-learning model update and broadcast architecture 100 may be an industrial IoT system in some examples. The decentralized active-learning model update and broadcast architecture 100 includes a plurality of edge devices 106 that include a first edge device 106a-N edge device 106n. The plurality of edge devices 106 may be of different types from each other or the same. The plurality of edge devices 106 may generate errors (e.g., be unable to perform a desired action, execute an action incorrectly, etc.) during processing that are to be corrected.

In order to do so, the plurality of edge devices 106 may communicate with a publication-subscription communication layer 104 (e.g., a blockchain) to notify each other of model updates and errors. The plurality of edge devices 106 may decide whether to implement the AI model update 112 or decline the AI model update 112 based on an individual analysis of the model update for errors and corrections. The application layer 102 may organize the timing of the model updates to the plurality of edge devices 106 in both state and timing alignment to change the active learning workflow accordingly. Thus, the AI model update 112 may be determined and implemented in a decentralized way to avoid centralization and congestion to updates.

In further detail, embodiments include a distributed orchestrator agent (e.g., part of a control plane) on the first edge device 106a-N edge device 106n. The orchestrator agent may be decentralized, and operate within the first edge device 106a-N edge device 106n. Thus, there is no single point of failure in the decentralized active-learning model update and broadcast architecture 100 so that if a single edge device from the plurality of edge devices 106 fails, the decentralized active-learning model update and broadcast architecture 100 may still continue to identify and propagate model updates.

The N edge device 106n may include more computing resources than the first edge device 106a and hence includes a timing telemetry plug-in to provide timing telemetry updates to the orchestrator 102b. The first edge device 106a does not include as many computing resources as the N edge device 106n and hence does not include a timing telemetry plug-in. The orchestrator agents of the first edge device 106a-N edge device 106n may communicate with the orchestrator 102b of the application layer 102 to provide timing telemetry to the orchestrator 102b (e.g., specific time sensitive operations associated with model updates). The orchestrator 102b may operate as a timing mediator to process the timing telemetry (e.g., timing stamps) from the orchestrator agents in order to streamline data plane processes (e.g., model updates) with better timing alignment and awareness (e.g. rapid voting, low latency response time of consensus, etc.). For example, model updates may be deployed and executed so as to minimize impact on workflow in an industrial system. As described above, the plurality of edge devices 106 may determine when a model update is needed.

For example, the N edge device 106n may determine that the AI model update 112 is needed to correct an error 110. That is, the N edge device 106n is responsive to an identification of error 110 so as to remedy the error with the AI model update 112. For example, the error 110 may be an action that the N edge device 106n executed incorrectly or was unable to complete. The AI model update 112 may replace or upgrade an original model that generated the error. For example, the N edge 106n may have executed the action based on the original model which resulted in error 110. The N edge device 106n may generate the AI model update 112 to correct the error 110 which may have occurred during previous operations (e.g., execute the action without an error). The N edge device 106n may then implement the AI model update 112 (e.g., run a series of tests) to determine whether the AI model update 112 is to be implemented.

For example, the N edge device 106n may execute a series of tests, and determine whether an error or correct output is generated in response to each of the series of tests. If the AI model update 112 results in an overall improvement to execution (e.g., number of correct outputs increases and number of errors decreases relative to the original model), the N edge device 106n may release the AI model update 112 and vote that the AI model update 112 is to be implemented. If however, the AI model update 112 is found to increase the number of errors and decrease the amount of correct outputs, the AI model update 112 may be iteratively adjusted to increase the number of correct outputs and decrease the number of errors, while still ensuring that the error 110 is corrected. For example, a single training session to correct the error 110 may be ineffective due to tiny local gradience, so repeated training may continue until the AI model update 112 effectively corrects the error 110. When the AI model update 112 meets the final constraint function requirements, the local model training to generate the AI model update 112 is declared successful, and the AI model update 112 (e.g., a trained model) may update the original model. The final constraint requirement may correspond to an overall improvement in the accuracy (e.g., less errors) relative to the original model.

The AI model update 112, the validation and the vote 114 may be uploaded to the publication-subscription communication layer 104 and stored as shown in the AI model update, validation and total vote count 118. A hash value of the AI model update 112 may be stored in the AI model update, validation and total vote count 118 rather than the AI un-hashed model update 112. The first edge device 106a may identify the AI model update 112 from the publication-subscription communication layer 104 and retrieve the AI model update 112. The first edge device 106a may then implement the AI model update 112 (e.g., run a series of tests) to determine whether the AI model update 112 is to be implemented.

For example, the first edge device 106a may execute a series of tests, and determine whether an error or correct output is generated in response to each of the series of tests. The series of tests may be the same or different from the series of tests executed by the N edge device 106n or other edge devices. For example, if the first edge device 106a is dedicated to a first subset of data, the first edge device 106a may execute a first series of tests to test for the first subset of data. The N edge device 106n may be dedicated to a N subset of data different from the first subset of data, and so the N edge device 106n may execute the N series of tests to test for the N subset of data. Thus, the N series of tests may be different from the first series of data. If the AI model update 112 results in an overall improvement to the original model (e.g., number of correct outputs increases and errors decreases relative to the original model), the first edge device 106a may vote that the model update is to be implemented. If the AI model update 112 results in a degradation to performance relative to the original model (e.g., a number of errors increases and a number of correct answers decreases), the first edge device 106a may vote to not implement the AI model update 112. The first edge device 106a uploads the validation (e.g., the results of the series of tests) and the vote 116 to the publication-subscription communication layer 104. The validation and vote 116 from the first edge device 106a may be stored as part of the AI model update, validation and total vote count 118. Each of the plurality of edge devices 106 may execute a retrieval, validation and voting process similar to the above as described with respect to the first edge device 106a.

The orchestrator 102b may determine whether the AI model update 112 is to be implemented based on a total of the votes from the plurality of edge devices 106 and results of the series of tests (i.e., validations) read from the AI model update, validation and total vote count 118, and control the publication-subscription communication layer 104 to deploy the AI model update 112 to the plurality of edge devices 106 (e.g., IoT devices) if so. In some embodiments, each of the votes may be weighted based on a weighting factor. For example, if the N edge device 106n executes more tests (e.g., executes more functions) than the first edge device 106a, the vote of the N edge device 106n may be more heavily weighted than the first edge device 106a, and generate corresponding weighting factors. In such embodiments, the AI mode update 112 may be determined to be selected if a total amount of votes meets a threshold. Otherwise, if the amount of votes indicates that the AI model update 112 is to be declined, the AI model update, validation and total vote count 118 may be deleted and removed from the publication-subscription communication layer 104. In some embodiments, the votes from the plurality of edge devices 106 are the validation (e.g., the results of the series of tests) multiplied by weighting factors. The orchestrator 102b identifies weight parameters for the plurality of edge devices 106. The orchestrator 102b determines each of the weight parameters based on a number of local errors that are correctable by the AI model update 112 for a respective edge device of the plurality of edge devices 106, and potential new errors for the respective edge device that are caused by the AI model update 112. For example, suppose that the AI model update 112 is tested for 4 local error cases (e.g., actions that were executed incorrectly by the original model) and 4 correct cases (e.g., actions that were executed correctly by the original model) on the N edge device 106n. Each of the local error cases may be weighted so that a correct outcome for the local error (which may be assigned a first initial value) is multiplied by a positive weight (number) and an incorrect outcome (which may be assigned a second initial value) may be multiplied by a negative weight, a zero weight or bypassed altogether to omit from voting. Correct outcomes (which may be assigned a third initial value) for the normal cases may be multiplied by a positive weight (or bypassed), while an incorrect outcome (which may be assigned a fourth initial value) for the normal cases may be multiplied by a negative weight(s). The vote of N edge device 106n may be a summation of the outcomes for the error and normal cases multiplied by respective weights.

In some examples, the orchestrator 102b may determine whether a simple majority of the votes (e.g., 50% or more of a highest number of possible votes) indicates that the AI model update 112 is to be implemented, and implement the AI model update if so. In some examples, the orchestrator 102b may determine whether a super majority of the votes indicate that the AI model update 112 is to be implemented, and implement the AI model update 112 if so. In some examples, the orchestrator 102b may determine whether a total number of errors across the plurality of edge devices 106 decreases when the AI model update 112 is implemented as compared to a total number of errors of the original model, and implement the AI model update 112 if so. Combinations of the above may be implemented (e.g., determine whether to implement the model update based on the number of votes and whether the total number of errors decreases). If the AI model update 112 is to be implemented, the application layer 102 may store the AI model update 112 as the active learning model update 102a, and deploy the active learning model update 102a at different times to various ones of the plurality of edge devices 106 based on timing requirements determined by the orchestrator 102b.

In this example, the publications-subscription communication layer 104 may store a series of transactions in a blockchain. Model updates which are accepted, are retained in the blockchain in association with the votes and results of the series of tests. The blockchain is accessible to the application layer 102 and the plurality of edge device 106. If the AI model update 112 is not accepted, the transaction of the AI model update 112 is removed from the blockchain.

Thus, a decentralized model for updates is provided in which each of the first-N edge devices 106a-106n may cast a vote to accept or reject the model updates based on personalized tests and specific implementations of the first-N edge devices 106a-106n. Doing so may enhance efficiency and reduce an overall amount of errors that occur in the architecture 100.

Thus, the decentralized active-learning model update and broadcast architecture 100 includes a model solution (e.g., for an industrial environment) that contains optimized update and verification process of AI inference models, such as the AI model update 112, based on active learning, a decentralized Publication/Subscription pattern for release and validation of model updates, an enhanced consensus mechanism that implements model updates on the plurality of edge devices 106. The decentralized active-learning model update and broadcast architecture 100 further includes edge-native orchestrator agents on the plurality of edge devices 106 in a control plane to facilitate the above data plane functions for the decentralized active-learning model update and broadcast architecture 100. Moreover, the N edge device 106n may employ an iterative model improvement strategy that has a composite check of flexible local misjudgment records and positive records to ensure sensitivity to error's specificity and reduce over-fitting so as to generate the AI model update 112. Thus, a decentralized updated publication/subscription verification process for industrial AI edge devices, such as the plurality of edge devices 106, is provided. A consensus voting mechanism based on recalculated client weight from extra error covering and side-effect may be implemented as well.

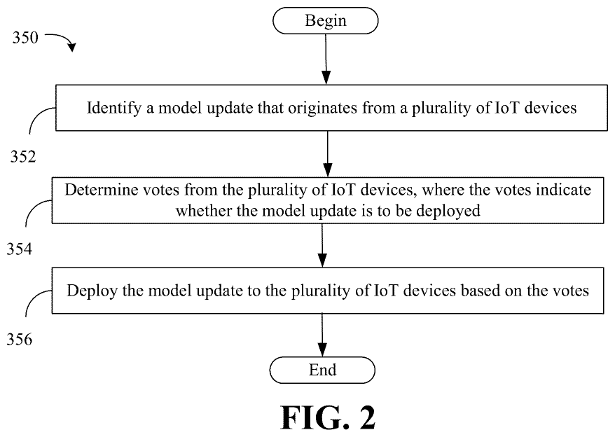

FIG. 2 shows a method 350 to generate and deploy a model update in an IoT environment. The method 350 may be readily combinable with any of the embodiments described herein. For example, the method 350 may implement and/or operate in conjunction with one or more aspects of the decentralized active-learning model update and broadcast architecture 100 (FIG. 1) already discussed. In an embodiment, the method 350 is implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 350 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 352 identifies a model update that originates from a plurality of IoT devices. Illustrated processing block 354 determines votes from the plurality of IoT devices, where the votes indicate whether the model update is to be deployed. Illustrated processing block 356 deploys the model update to the plurality of IoT devices based on the votes. In some examples, the method 350 includes identifying weight parameters for the plurality of IoT devices, where each of the weight parameters is determined based on a number of local errors that are correctable by the model update for a respective IoT device of the plurality of IoT devices, and potential new errors for the respective IoT device that are caused by the model update. In such examples, the method 350 further includes determining the votes based on a product of the weight parameters and the votes.

In some examples, the method 350 includes locally generating the model update in a respective IoT device of the plurality of IoT devices in response to an error being identified by the respective IoT device. In some examples, the method 350 includes repeatedly readjusting the model update until the model update rectifies an error prior to deployment of the model update to the plurality of IoT devices. In some examples, the method 350 includes broadcasting the model update and a voting ledger to the plurality of IoT devices, wherein the voting ledger will store the votes. In some examples, the method 350 includes generating a hash value of the model update, and recording the hash value and voting information associated with the votes to a blockchain.

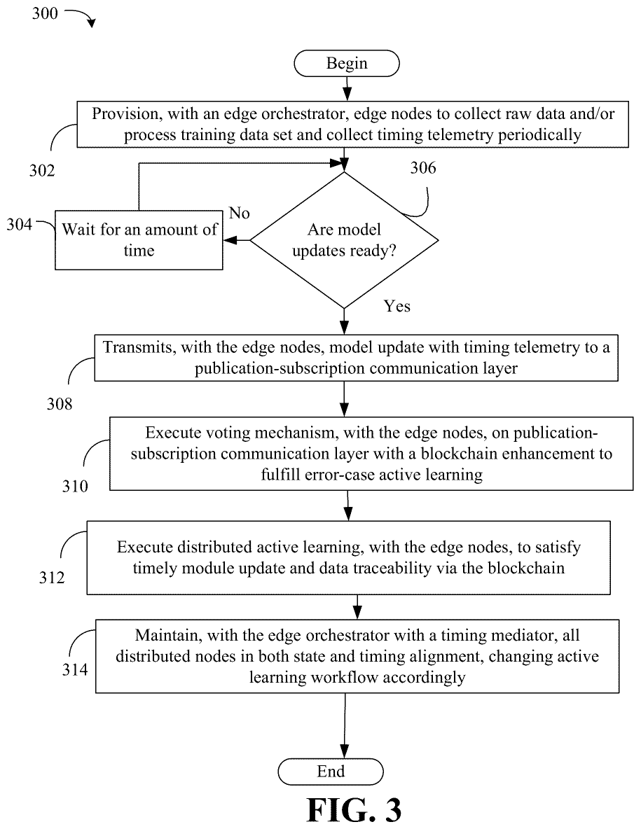

FIG. 3 shows a method 300 of implementing a model update. The method 300 may be readily combinable with any of the embodiments described herein. For example, the method 300 may implement and/or operate in conjunction with one or more aspects of the decentralized active-learning model update and broadcast architecture 100 (FIG. 1), and/or the method 350 (FIG. 2), already discussed. More particularly, the method 460 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS, TTL technology, or any combination thereof.

Illustrated processing block 302 provisions, with an edge orchestrator, edge nodes to collect raw data and/or process training data set and collect timing telemetry periodically. For example, the edge nodes may be provisioned with orchestrator agents to facilitate the collection of raw data and/or process training data sets. Illustrated processing block 306 determines if the model updates are ready. If not, illustrating processing block 304 waits for an amount of time before re-executing block 306. Illustrated processing block 308 transmits, with the edge nodes, model updates with timing telemetry to a publication-subscription communication layer. That is, each model update may be associated with a timing telemetry so as to determine when a model update was suggested. Illustrated processing block 310 executes a voting mechanism, with the edge nodes, on the publication-subscription communication layer with a blockchain enhancement to fulfill error-case active learning. The voting mechanism may be similar to as described above so that each of the edge devices may cast a vote, the votes may be tallied, and a decision may be formed based on the tallied votes. Illustrated processing block 312 executes distributed active learning, with the edge nodes, to satisfy timely module update and data traceability via the blockchain. For example, the blockchain may store a log of all updates as they occur, along with the votes and error corrections associated with the update, fulfilling accurate distinction and traceability. Illustrated processing block 314 maintains, with the edge orchestrator with a timing mediator, all distributed nodes in both state and timing alignment and changing active learning workflow accordingly. That is, the model updates may be propagated in a fashion to maintain state and timing alignment of the edge nodes and to not interfere with normal workflows.

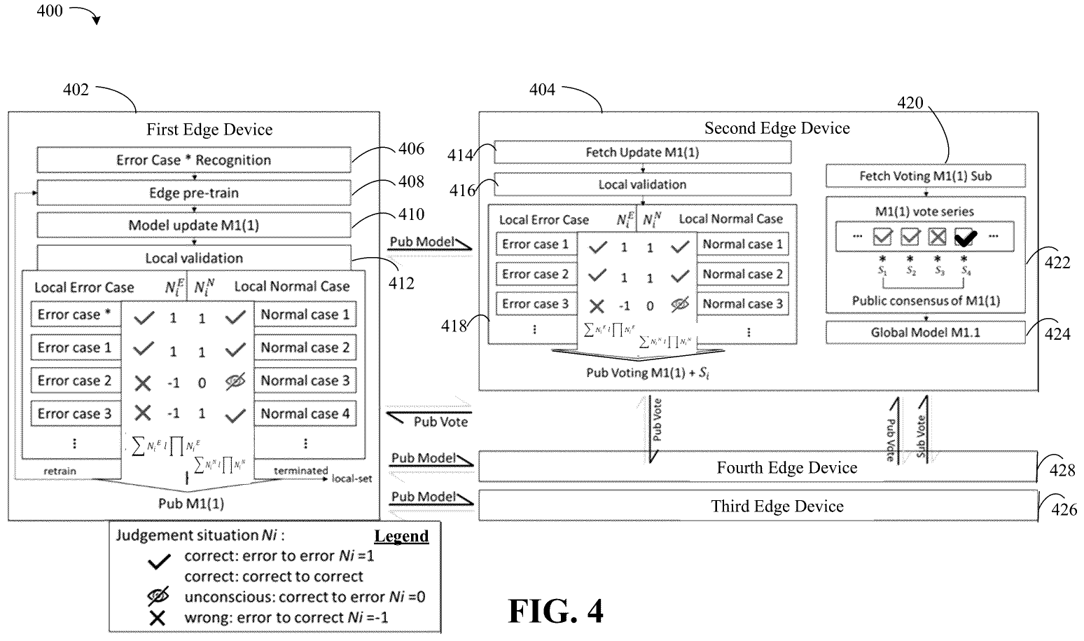

Turning now to FIG. 4, an architecture 400 for model updates is provided. In this example, first, second, third and fourth edge devices 402, 404, 428, 426 are provided. The respective actions of the first and second edge devices 402, 404 are illustrated as being within the respective first and second edge devices 402, 404.

Initially, a distributed model training is implemented at first edge device 402. The model flow update includes an error case* recognition (e.g., for an original model M1) at block 406. That is, the first edge device 402 recognizes that an error case* for the original model M1 has occurred. The first edge device 402, responsive to the recognition of the error case*, then attempts to remedy this error case* as described below. The first edge device 402 then undergoes an edge pre-training 408 to execute an active learning and training model. The active learning and training model may iteratively generate an update to remedy the error case*. The output of the edge pre-training 408 is an update model to model M1 that remedies the error case*. The update model may be referred to as model update M1(1) 410 for simplicity.

The local validation 412 then executes. The local validation 412 may execute a series of tests based on the model update M1(1). Each of the tests may be based on different error cases (where the original model M(1) executed incorrectly) and normal cases (where the original model executed correctly). In this example, execution of the updated model M1(1) by the first edge device 402 results in correct outcomes for error case* (which is the original error), error case 1, normal case 1, normal case 2 and normal case 4. For example, in a machine vision system to detect the defect samples in manufacturing, the error case would mean samples with defects while the normal case would stand for normal and good samples. Execution of the updated model M1(1) by the first edge device 402 results in incorrect outcomes for error case 2 and error case 3. The model update M1(1) may execute the normal case 3 incorrectly. The normal case 3 was previously correct when the original model M1 is executed. Thus, a total of 5 test cases are correct while 3 are incorrect, resulting in an overall improvement from the original model M1. That is, according to original model M1, 4 test cases (error case*-error case 3) were incorrect while normal 4 cases (cases 1-4) were correct.

The first edge device 402 may then publish the updated model M1(1) (e.g., to a publication-subscription communication layer). The second edge device 404 fetches the model update M1(1) 414, for example, from the publication-subscription communication layer. The second edge device 404 then executes a local validation 416 on the updated model M1(1). The local validation 416 includes a plurality of cases 418. For example, similar to above description of the first edge device 402, the second edge device 404 executes, with the model update M1(1), a series of tests to test for error cases 1-3 and additional error tests (unillustrated), and then executes normal cases 1-3 and additional normal tests (unillustrated). As illustrated, execution of the model update M1(1) results in correct outcomes for error case 1, error case 2, normal case 1 and normal case 2, and incorrect outcomes for error cases 3 and normal case 3.

The second edge device 404 may then fetch a voting M1(1) subscription 420 to vote. The model update M1(1) vote series 422 is illustrated, which shows that a public consensus of the updated model M1(1) in which 4 of entries forming part of the vote of the first edge device 402 are illustrated. That is, the illustrated M1(1) vote series 422 includes the normal cases 1-4 of the local validation 412 of the first edge device 402 multiplied by weights s1-s4 which may be selected based on whether a correct or incorrect outcome was reached. For example, the normal case 1 has a correct outcome and is multiplied by a first weight s1 (e.g., a positive weight) as a result. The normal case 2 has a correct outcome and is multiplied by a second weight s2 (e.g., a positive weight) as a result. The normal case 3 has an incorrect outcome and is multiplied by a third weight s3 (e.g., a negative weight) as a result. The normal case 4 has a correct outcome and is multiplied by a fourth weight s4 (e.g., a positive weight) as a result. The normal case and error cases may each be assigned a value based on whether a correct or incorrect value was identified and then multiplied by a respective weight s1-s4. An overall vote of the first edge device 402 may be a summation of all the outcomes of the normal and error cases multiplied by respective weights including weights s1-s4.

Similar to the above, the second edge device 404 may add the vote of the second edge device 404 to the M1(1) vote series 422. That is, the outcomes of the tests and weights may be added to the M1(1) vote series.

In some examples, the weights may be based in part on the importance of the edge device that cast the respective vote. For example, if a respective edge device is of high importance (e.g., relatively important tasks performed by the edge device, executes a relatively high number of operations, etc.) the respective edge device may have higher weights assigned to the outcomes of the respective edge device to heavily weight the vote. If however an edge device is of low importance (e.g., relatively low tasks performed by the edge device, executes a relatively low number of operations, etc.) the edge device may have a low weight assigned to the vote to lower the influence of the vote. Thus, the outcomes may be multiplied by the weights (e.g., weights s1-s4) to provide a more efficient analysis that results in better overall outcomes.

A consensus may be reached based on the model update ml(1) vote series 422 so that the updated model M1(1) is set as the global model ml(1) 424. For example, each of the outcomes (which may be assigned a value of 0 or 1 depending on whether an incorrect or correct outcome is achieved) may be multiplied by a respective weight to generate a weighted value, and the weighted values may be summed together to generate a final value. If the final value reaches a threshold (e.g., a value that is greater than a value that is 50% or more of the number of the total votes that are cast), the updated model M1(1) may be accepted and deployed. In this example, the updated model M1(1) is accepted. The third and fourth edge devices 426, 428 may execute similar processes as described above with respect to the second edge device 404.

In some embodiments, a user may judge the terminal identification results at a selected time, and if a case of system miscalculation occurs, (e.g., Error-Case* (EC*)), the first-fourth edge devices 402, 404, 426, 428 automatically records to the list of errors (EC-List), (EC*, EC1, EC2, . . . ). As discussed above, validation, such as local validations 412, 416, are divided into two parts: verifying that the model update M1(1) (e.g., the new-model) meets the correct recognition at least of EC* and other ECs, while verifying that the saved normal cases (e.g., normal cases 1-4) sequence's (N-List's) penalty function, results in no significant additional misjudgments. A single training session may be ineffective due to tiny local gradience, so the first edge device 402 may engage in repeated training until the model update M1(1) (or a variation thereupon) effectively corrects EC*. When the model update M1(1) meets the final constraint function requirements, the local model training is declared successful, the trained model is M1(1), the update matrix is M(1). For example, the trained model is model update M1(1), and the updated candidate model is M(1).

After the successful validation by the first edge node 402, the model update M1(1) and the corresponding voting public ledger S(1) are broadcast to all other edge devices, such as the second, third and fourth edge devices 404, 428, 426, through the publication/subscription mechanism to begin the distributed verification process by second, third and fourth edge nodes 404, 428, 426.

As discussed above, each of the second, third and fourth edge devices 404, 428, 426 begins a local validation routine, using the same validation process as the first edge device 402, and based on a local ES-List and N-List. Additionally, the second, third and fourth edge devices 404, 428, 426 may employ a principle that no additional misjudgment is to be added to the verification process which may exclude some model updates. For example, in this example since model update M1(1) misjudges the normal case 3 while the original model M1 did not, the model update M1(1) may be rejected since the model update M1(1) interjects an added error relative to the model M1.

Once the validation is complete, validation conclusion may be added to the voting ledger and broadcast the new publication to blockchain (e.g., publication-subscription communication layer). If the model update M1(1) is determined to be valid, each of first, second, third and fourth edge devices 402, 404, 428, 426 is updated to the latest model M1(1). If the model update M1(1) is not adopted, an entry corresponding to S(1) in the blockchain and model update M1(1) are destroyed. In such a case, the first, second, third and fourth edge devices 402, 404, 428, 426 continue to maintain the model M1, which was completed by the last recent validation.

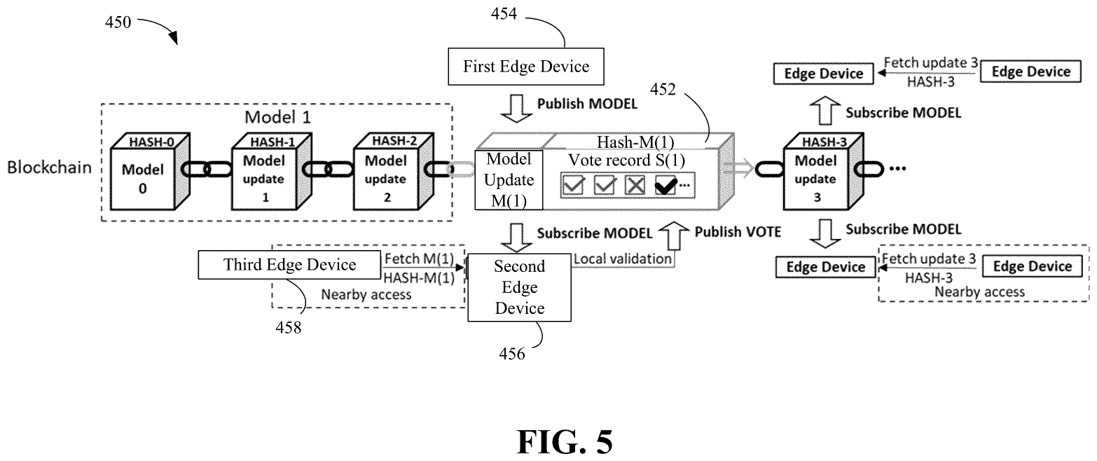

FIG. 5 illustrates a publication subscription system 450 combined with a blockchain mechanism. The publication subscription system 450 facilitate a distributed and efficient storage mechanism that is accessible by edge nodes. The publication subscription system 450 may employ a “records on chain and transmission beneath” model. A hash value of model update M(1) is calculated, and only the Hash value HASH-M(1) and the voting information S(1) of distributed verification are recorded on the blockchain at entry 452. Each of the entries may be multiplied by a weight. For example, a first edge device 454 may provide the model update m(1) and also update a vote record S(1) (outcomes of validation testing) of the entry 452. A second edge device 456 may retrieve the model update M(1). After a second edge device 456 retrieves the latest information, a third edge device 458 may fetch the model update m(1) from the second edge device 456 via nearby access to the second edge device 456. Doing so ensures the security of transmission, saves the transmission consumption when updating the model update M(1), and unlocks the tolerance of broker byzantine faults.

Once the validation by the second and third edge devices 456, 458 is complete, a validation conclusion of the second and third edge devices 456, 458 may be permanently added to the voting ledger of the publication subscription system 450. If the model update S(1) is determined to be valid, each of first, second, and third edge devices 454, 456, 458 is updated to the latest model M1(1). If the consensus is not adopted, the entry 452 including the ledger S(1) and model update M1 are destroyed. The terminals continue to maintain the model M1, which was completed by the last recent validation in model update 2. The publication subscription system 450 combined with blockchain mechanism also benefit from the data traceability from most distributed ledger system thus renders extra data protection on sensitive module updates.

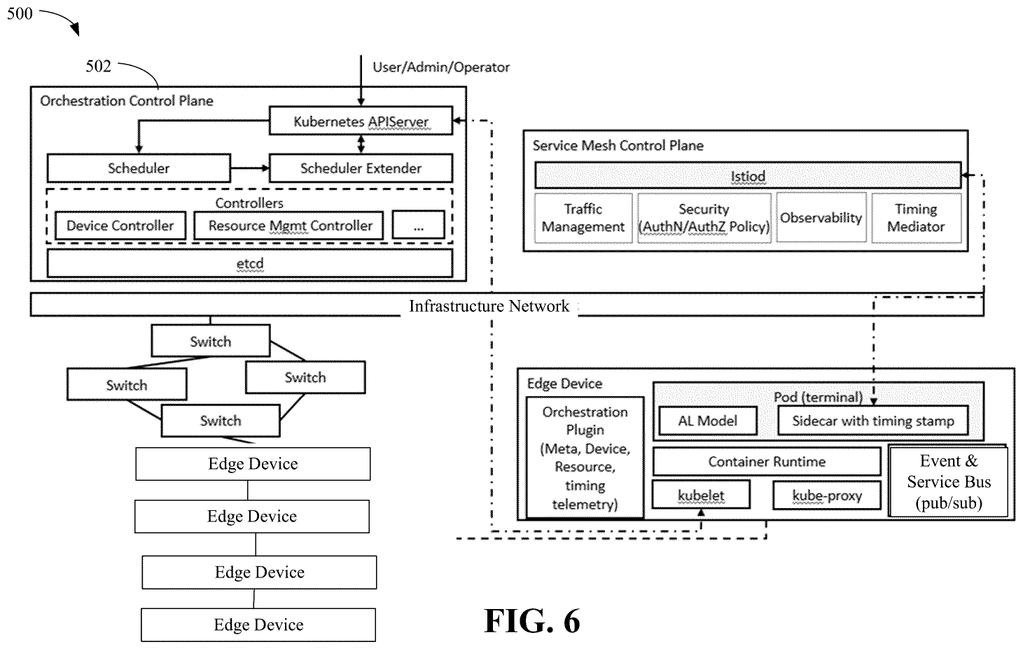

FIG. 6 illustrates distributed update architecture 500. The architecture 500 includes an edge orchestration control plane 502. The edge orchestration control plane 502 may utilize services in traditional container orchestration system (e.g., Kubernetes) to deploy the detection terminals (with init AL model) and necessary middleware (e.g., publication subscription service) to implement voting mechanism on all edge devices. This provision may be coordinated by the orchestration control plane 502 in a decentralized manner, resulting in a more light-weight and robust implementation.

After the provisioning, an active learning and voting mechanism is enabled. Moreover, some embodiments may be augmented with industrial IoT specific extensions for better workload scheduling decisions (e.g., Quality-of-Service (QOS)). In some embodiments, a service mesh (e.g., Istio) can be applied seamlessly using the sidecar design pattern to provide additional manageability, security, observability, and extensibility for the invention. For such distributed active learning use cases, a specific timing mediator is added into service mesh control plane to process the timing telemetry (e.g. timing stamp within edge pod's sidecar) in order to streamline data plane process with better timing alignment and awareness (e.g. quick voting, fast response time of consensus).

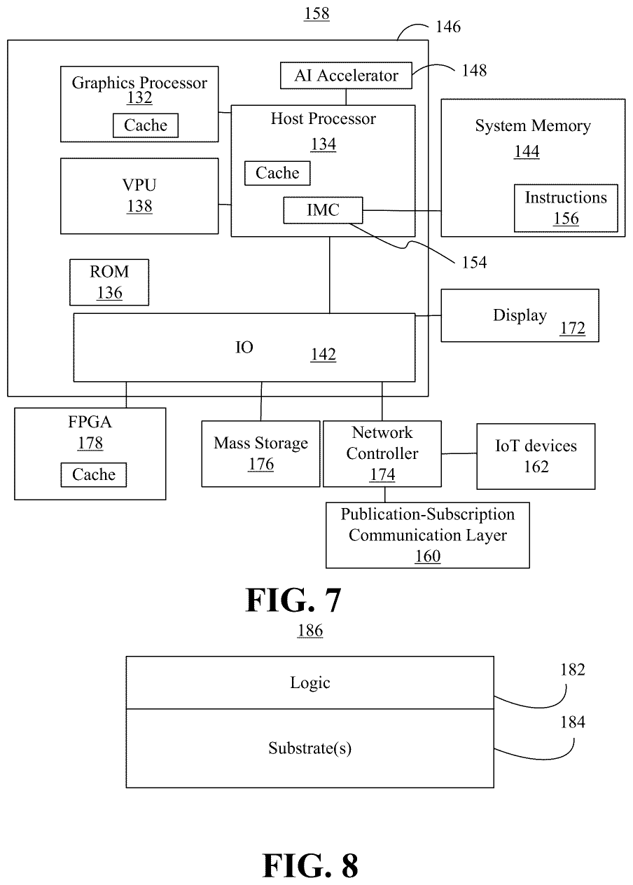

Turning now to FIG. 7, a performance enhanced computing system 158 is shown. The computing system 158 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), etc., or any combination thereof. In the illustrated example, the computing system 158 includes a host processor 134 (e.g., CPU) having an integrated memory controller (IMC) 154 that is coupled to a system memory 144.

The illustrated computing system 158 also includes an input output (IO) module 142 implemented together with the host processor 134, a graphics processor 132 (e.g., GPU), ROM 136, and AI accelerator 148 on a semiconductor die 146 as a system on chip (SoC). The illustrated IO module 142 communicates with, for example, a display 172 (e.g., touch screen, liquid crystal display/LCD, light emitting diode/LED display), a network controller 174 (e.g., wired and/or wireless), FPGA 178 and mass storage 176 (e.g., hard disk drive/HDD, optical disk, solid state drive/SSD, flash memory). Furthermore, the SoC 146 may further include processors (not shown) and/or the AI accelerator 148 dedicated to artificial intelligence (AI) and/or neural network (NN) processing. For example, the system SoC 146 may include a vision processing unit (VPU) 138 and/or other AI/NN-specific processors such as AI accelerator 148, etc.

The graphics processor 132 and/or the host processor 134 may execute instructions 156 retrieved from the system memory 144 (e.g., a dynamic random-access memory) and/or the mass storage 176 to implement aspects as described herein. For example, the graphics processor 132 and/or the host processor 134 may communicate with IoT devices 162 and publication-subscription communication layer 160 through the network controller 174 to retrieve voting information, telemetry information, model updates, etc. Furthermore, the instructions 156, when executed cause the computing system 158 to identify a model update that originates from the IoT devices 162, determine votes from the IoT devices, where the votes indicate whether the model update is to be deployed, and deploy the model update to the IoT devices based on the votes. When the instructions 156 are executed, the computing system 158 may implement one or more aspects of the embodiments described herein. For example, the computing system 158 may implement one or more aspects of the decentralized active-learning model update and broadcast architecture 100 (FIG. 1), the method 350 (FIG. 2), the method 300 (FIG. 3), architecture 400 (FIG. 4), publication subscription system 450 (FIG. 5) and/or distributed update architecture 500 (FIG. 6) already discussed. The illustrated computing system 158 is therefore considered to be performance-enhanced at least to the extent that it enables the computing system 158 to determine model updates based on suggestions from the IoT devices 162 and votes from the IoT devices 162.

FIG. 8 shows a semiconductor apparatus 186 (e.g., chip, die, package). The illustrated apparatus 186 includes one or more substrates 184 (e.g., silicon, sapphire, gallium arsenide) and logic 182 (e.g., transistor array and other integrated circuit/IC components) coupled to the substrate(s) 184. In an embodiment, the apparatus 186 is operated in an application development stage and the logic 182 performs one or more aspects of the embodiments described herein, for example, one or more aspects of the decentralized active-learning model update and broadcast architecture 100 (FIG. 1), the method 350 (FIG. 2), the method 300 (FIG. 3), architecture 400 (FIG. 4), publication subscription system 450 (FIG. 5) and/or distributed update architecture 500 (FIG. 6) already discussed. The logic 182 may be implemented at least partly in configurable logic or fixed-functionality hardware logic. In one example, the logic 182 includes transistor channel regions that are positioned (e.g., embedded) within the substrate(s) 184. Thus, the interface between the logic 182 and the substrate(s) 184 may not be an abrupt junction. The logic 182 may also be considered to include an epitaxial layer that is grown on an initial wafer of the substrate(s) 184.

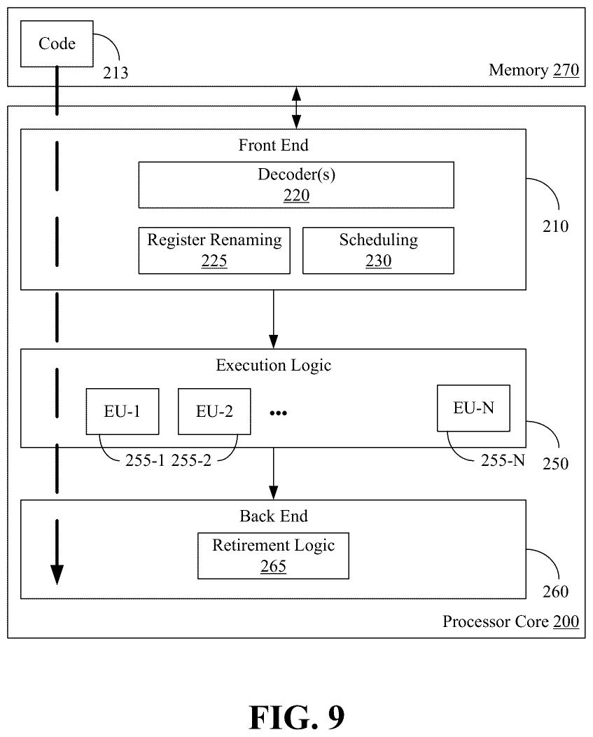

FIG. 9 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 9, a processing element may alternatively include more than one of the processor core 200 illustrated in FIG. 9. The processor core 200 may be a single-threaded core or, for at least one embodiment, the processor core 200 may be multithreaded in that it may include more than one hardware thread context (or “logical processor”) per core.

FIG. 9 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the embodiments such as, for example, the decentralized active-learning model update and broadcast architecture 100 (FIG. 1), the method 350 (FIG. 2), the method 300 (FIG. 3), architecture 400 (FIG. 4), publication subscription system 450 (FIG. 5) and/or distributed update architecture 500 (FIG. 6) already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 9, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

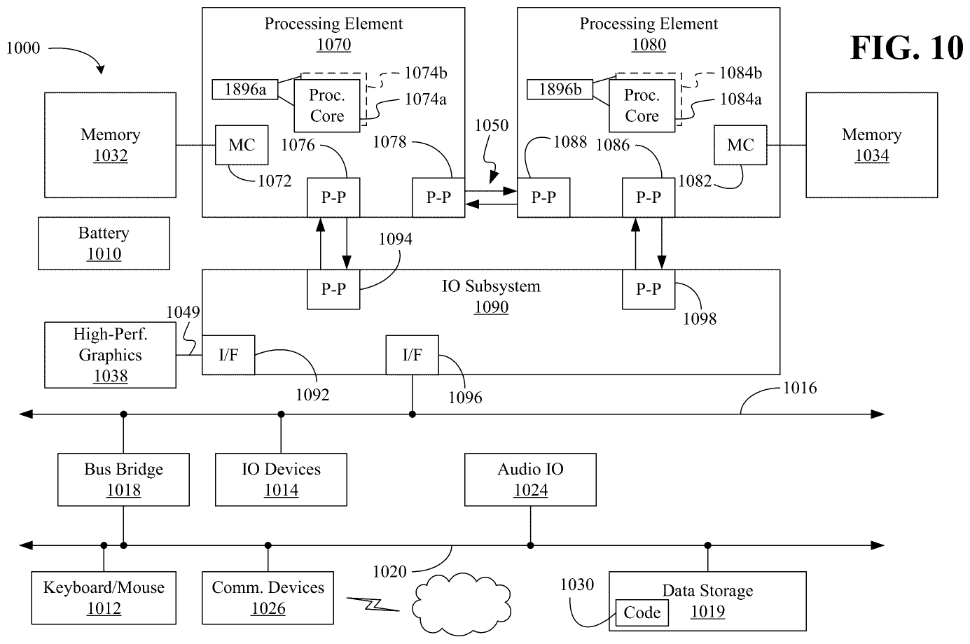

Referring now to FIG. 10, shown is a block diagram of a computing system 1000 embodiment in accordance with an embodiment. Shown in FIG. 10 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 10 may be implemented as a multi-drop bus rather than point-to-point interconnect.

As shown in FIG. 10, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 9.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 10, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 10, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments is not so limited.

As shown in FIG. 10, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement one or more aspects of the decentralized active-learning model update and broadcast architecture 100 (FIG. 1), the method 350 (FIG. 2), the method 300 (FIG. 3), architecture 400 (FIG. 4), publication subscription system 450 (FIG. 5) and/or distributed update architecture 500 (FIG. 6) already discussed. Further, an audio I/O 1024 may be coupled to second bus 1020 and a battery 1010 may supply power to the computing system 1000.

Note that other embodiments are contemplated. For example, instead of the point-to-point architecture of FIG. 10, a system may implement a multi-drop bus or another such communication topology. Also, the elements of FIG. 10 may alternatively be partitioned using more or fewer integrated chips than shown in FIG. 10.

### Additional Notes and Examples

Example 1 includes a computing system comprising a network controller to communicate with a plurality of internet-of-things (IoT) devices, a processor coupled to the network controller, and a memory coupled to the processor, the memory including a set of executable program instructions, which when executed by the processor, cause the computing system to identify a model update that is to originate from the plurality of IoT devices, determine votes from the plurality of IoT devices, wherein the votes indicate whether the model update is to be deployed, and deploy the model update to the plurality of IoT devices based on the votes.

Example 2 includes the computing system of Example 1, wherein the executable program instructions, when executed, cause the computing system to identify weight parameters for the plurality of IoT devices, wherein the weight parameters are associated with local errors that are correctable by the model update for a respective IoT device of the plurality of IoT devices, and potential new errors for the respective IoT device that are caused by the model update, and determine the votes based on a product of the weight parameters and outcomes of tests associated with the model update.

Example 3 includes the computing system of any one of Examples 1 to 2, wherein the executable program instructions, when executed, cause the computing system to locally generate the model update in a respective IoT device of the plurality of IoT devices in response to an error being identified by the respective IoT device.

Example 4 includes the computing system of any one of Examples 1 to 3, wherein the executable program instructions, when executed, cause the computing system to repeatedly readjust the model update until the model update rectifies an error prior to deployment of the model update to the plurality of IoT devices.

Example 5 includes the computing system of any one of Examples 1 to 4, wherein the executable program instructions, when executed, cause the computing system to broadcast the model update and a voting ledger to the plurality of IoT devices, wherein the voting ledger is to store the votes.

Example 6 includes the computing system of any one of Examples 1 to 5, wherein the executable program instructions, when executed, cause the computing system to generate a hash value of the model update, and record the hash value and voting information associated with the votes to a blockchain.

Example 7 includes a semiconductor apparatus comprising one or more substrates, and logic coupled to the one or more substrates, wherein the logic is implemented in one or more of configurable or fixed-functionality hardware, the logic to identify a model update that is to originate from a plurality of IoT devices, determine votes from the plurality of IoT devices, wherein the votes indicate whether the model update is to be deployed, and deploy the model update to the plurality of IoT devices based on the votes.

Example 8 includes the apparatus of Example 7, wherein the logic coupled to the one or more substrates is to identify weight parameters for the plurality of IoT devices, wherein the weight parameters are associated with local errors that are correctable by the model update for a respective IoT device of the plurality of IoT devices, and potential new errors for the respective IoT device that are caused by the model update, and determine the votes based on a product of the weight parameters and outcomes of tests associated with the model update.

Example 9 includes the apparatus of any one of Examples 7 to 8, wherein the logic coupled to the one or more substrates is to locally generate the model update in a respective IoT device of the plurality of IoT devices in response to an error being identified by the respective IoT device.

Example 10 includes the apparatus of any one of Examples 7 to 9, wherein the logic coupled to the one or more substrates is to repeatedly readjust the model update until the model update rectifies an error prior to deployment of the model update to the plurality of IoT devices.

Example 11 includes the apparatus of any one of Examples 7 to 10, wherein the logic coupled to the one or more substrates is to broadcast the model update and a voting ledger to the plurality of IoT devices, wherein the voting ledger is to store the votes.

Example 12 includes the apparatus of any one of Examples 7 to 11, wherein the logic coupled to the one or more substrates is to generate a hash value of the model update, and record the hash value and voting information associated with the votes to a blockchain.

Example 13 includes the apparatus of any one of Examples 7 to 12, wherein the logic coupled to the one or more substrates includes transistor channel regions that are positioned within the one or more substrates.

Example 14 includes at least one computer readable storage medium comprising a set of executable program instructions, which when executed by a computing system, cause the computing system to identify a model update that is to originate from a plurality of IoT devices, determine votes from the plurality of IoT devices, wherein the votes indicate whether the model update is to be deployed, and deploy the model update to the plurality of IoT devices based on the votes.

Example 15 includes the at least one computer readable storage medium of Example 14, wherein the instructions, when executed, further cause the computing system to identify weight parameters for the plurality of IoT devices, wherein the weight parameters are associated with local errors that are correctable by the model update for a respective IoT device of the plurality of IoT devices, and potential new errors for the respective IoT device that are caused by the model update, and determine the votes based on a product of the weight parameters and outcomes of tests associated with the model update.

Example 16 includes the at least one computer readable storage medium of any one of Examples 14 to 15, wherein the instructions, when executed, further cause the computing system to locally generate the model update in a respective IoT device of the plurality of IoT devices in response to an error being identified by the respective IoT device.

Example 17 includes the at least one computer readable storage medium of any one of Examples 14 to 16, wherein the instructions, when executed, further cause the computing system to repeatedly readjust the model update until the model update rectifies an error prior to deployment of the model update to the plurality of IoT devices.

Example 18 includes the at least one computer readable storage medium of any one of Examples 14 to 17, wherein the instructions, when executed, further cause the computing system to broadcast the model update and a voting ledger to the plurality of IoT devices, wherein the voting ledger is to store the votes.

Example 19 includes the at least one computer readable storage medium of any one of Examples 14 to 18, wherein the instructions, when executed, further cause the computing system to generate a hash value of the model update, and record the hash value and voting information associated with the votes to a blockchain.

Example 20 includes a method comprising identifying a model update that originates from a plurality of IoT devices, determining votes from the plurality of IoT devices, wherein the votes indicate whether the model update will be deployed, and deploying the model update to the plurality of IoT devices based on the votes.

Example 21 includes the method of Example 20, further comprising identifying weight parameters for the plurality of IoT devices, wherein the weight parameters are associated with local errors that are correctable by the model update for a respective IoT device of the plurality of IoT devices, and potential new errors for the respective IoT device that are caused by the model update, and determining the votes based on a product of the weight parameters and outcomes of tests associated with the model update.

Example 22 includes the method of any one of Examples 20 to 21, further comprising locally generating the model update in a respective IoT device of the plurality of IoT devices in response to an error being identified by the respective IoT device.

Example 23 includes the method of any one of Examples 20 to 22, further comprising repeatedly readjusting the model update until the model update rectifies an error prior to deployment of the model update to the plurality of IoT devices.

Example 24 includes the method of any one of Examples 20 to 23, further comprising broadcasting the model update and a voting ledger to the plurality of IoT devices, wherein the voting ledger will store the votes.

Example 25 includes the method of any one of Examples 20 to 24, further comprising generating a hash value of the model update, and recording the hash value and voting information associated with the votes to a blockchain.

Example 26 includes an apparatus comprising means for identifying a model update that originates from a plurality of IoT devices, means for determining votes from the plurality of IoT devices, wherein the votes are to indicate whether the model update will be deployed, and means for deploying the model update to the plurality of IoT devices based on the votes.

Example 27 includes the apparatus of Example 26, further comprising means for identifying weight parameters for the plurality of IoT devices, wherein the weight parameters are associated with local errors that are correctable by the model update for a respective IoT device of the plurality of IoT devices, and potential new errors for the respective IoT device that are caused by the model update, and means for determining the votes based on a product of the weight parameters and outcomes of tests associated with the model update.

Example 28 includes the apparatus of any one of Examples 26 to 27, further comprising means for locally generating the model update in a respective IoT device of the plurality of IoT devices in response to an error being identified by the respective IoT device.

Example 29 includes the apparatus of any one of Examples 26 to 28, further comprising means for repeatedly readjusting the model update until the model update rectifies an error prior to deployment of the model update to the plurality of IoT devices.

Example 30 includes the apparatus of any one of Examples 26 to 29, further comprising means for broadcasting the model update and a voting ledger to the plurality of IoT devices, wherein the voting ledger will store the votes.

Example 31 includes the apparatus of any one of Examples 26 to 30, further comprising means for generating a hash value of the model update, and means for recording the hash value and voting information associated with the votes to a blockchain.

Thus, technology described herein may provide for an enhanced system that enables decentralized updates in an IoT system. The system may also be based on voting by IoT devices to facilitate a sound decision making process.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller to communicate with a plurality of internet-of-things (IoT) devices;
a processor coupled to the network controller; and
a memory coupled to the processor, the memory including a set of executable program instructions, which when executed by the processor, cause the computing system to:
identify a model update that is to originate from the plurality of IoT devices;
determine votes from the plurality of IoT devices, wherein the votes indicate whether the model update is to be deployed; and
deploy the model update to the plurality of IoT devices based on the votes.

2. The computing system of claim 1, wherein the executable program instructions, when executed, cause the computing system to:
identify weight parameters for the plurality of IoT devices, wherein the weight parameters are associated with local errors that are correctable by the model update for a respective IoT device of the plurality of IoT devices, and potential new errors for the respective IoT device that are caused by the model update; and
determine the votes based on a product of the weight parameters and outcomes of tests associated with the model update.

3. The computing system of claim 1, wherein the executable program instructions, when executed, cause the computing system to:
locally generate the model update in a respective IoT device of the plurality of IoT devices in response to an error being identified by the respective IoT device.

4. The computing system of claim 1, wherein the executable program instructions, when executed, cause the computing system to:
repeatedly readjust the model update until the model update rectifies an error prior to deployment of the model update to the plurality of IoT devices.

5. The computing system of claim 1, wherein the executable program instructions, when executed, cause the computing system to:
broadcast the model update and a voting ledger to the plurality of IoT devices, wherein the voting ledger is to store the votes.

6. The computing system of claim 1, wherein the executable program instructions, when executed, cause the computing system to:
generate a hash value of the model update; and
record the hash value and voting information associated with the votes to a blockchain.

7. A semiconductor apparatus comprising:
one or more substrates; and
logic coupled to the one or more substrates, wherein the logic is implemented in one or more of configurable or fixed-functionality hardware, the logic to:
identify a model update that is to originate from a plurality of IoT devices;
determine votes from the plurality of IoT devices, wherein the votes indicate whether the model update is to be deployed; and
deploy the model update to the plurality of IoT devices based on the votes.

8. The apparatus of claim 7, wherein the logic coupled to the one or more substrates is to:
identify weight parameters for the plurality of IoT devices, wherein the weight parameters are associated with local errors that are correctable by the model update for a respective IoT device of the plurality of IoT devices, and potential new errors for the respective IoT device that are caused by the model update; and
determine the votes based on a product of the weight parameters and outcomes of tests associated with the model update.

9. The apparatus of claim 7, wherein the logic coupled to the one or more substrates is to:
locally generate the model update in a respective IoT device of the plurality of IoT devices in response to an error being identified by the respective IoT device.

10. The apparatus of claim 7, wherein the logic coupled to the one or more substrates is to:
repeatedly readjust the model update until the model update rectifies an error prior to deployment of the model update to the plurality of IoT devices.

11. The apparatus of claim 7, wherein the logic coupled to the one or more substrates is to:
broadcast the model update and a voting ledger to the plurality of IoT devices, wherein the voting ledger is to store the votes.

12. The apparatus of claim 7, wherein the logic coupled to the one or more substrates is to:
generate a hash value of the model update; and
record the hash value and voting information associated with the votes to a blockchain.

13. The apparatus of claim 7, wherein the logic coupled to the one or more substrates includes transistor channel regions that are positioned within the one or more substrates.

14. At least one computer readable storage medium comprising a set of executable program instructions, which when executed by a computing system, cause the computing system to:
identify a model update that is to originate from a plurality of IoT devices;
determine votes from the plurality of IoT devices, wherein the votes indicate whether the model update is to be deployed; and
deploy the model update to the plurality of IoT devices based on the votes.

15. The at least one computer readable storage medium of claim 14, wherein the instructions, when executed, further cause the computing system to:
identify weight parameters for the plurality of IoT devices, wherein the weight parameters are associated with local errors that are correctable by the model update for a respective IoT device of the plurality of IoT devices, and potential new errors for the respective IoT device that are caused by the model update; and
determine the votes based on a product of the weight parameters and outcomes of tests associated with the model update.

16. The at least one computer readable storage medium of claim 14, wherein the instructions, when executed, further cause the computing system to:
locally generate the model update in a respective IoT device of the plurality of IoT devices in response to an error being identified by the respective IoT device.

17. The at least one computer readable storage medium of claim 14, wherein the instructions, when executed, further cause the computing system to:
repeatedly readjust the model update until the model update rectifies an error prior to deployment of the model update to the plurality of IoT devices.

18. The at least one computer readable storage medium of claim 14, wherein the instructions, when executed, further cause the computing system to:
broadcast the model update and a voting ledger to the plurality of IoT devices, wherein the voting ledger is to store the votes.

19. The at least one computer readable storage medium of claim 14, wherein the instructions, when executed, further cause the computing system to:
generate a hash value of the model update; and
record the hash value and voting information associated with the votes to a blockchain.

20. A method comprising:
identifying a model update that originates from a plurality of IoT devices;
determining votes from the plurality of IoT devices, wherein the votes indicate whether the model update will be deployed; and
deploying the model update to the plurality of IoT devices based on the votes.

21. The method of claim 20, further comprising:
identifying weight parameters for the plurality of IoT devices, wherein the weight parameters are associated with local errors that are correctable by the model update for a respective IoT device of the plurality of IoT devices, and potential new errors for the respective IoT device that are caused by the model update; and
determining the votes based on a product of the weight parameters and outcomes of tests associated with the model update.

22. The method of claim 20, further comprising:
locally generating the model update in a respective IoT device of the plurality of IoT devices in response to an error being identified by the respective IoT device.

23. The method of claim 20, further comprising:
repeatedly readjusting the model update until the model update rectifies an error prior to deployment of the model update to the plurality of IoT devices.

24. The method of claim 20, further comprising:
broadcasting the model update and a voting ledger to the plurality of IoT devices, wherein the voting ledger will store the votes.

25. The method of claim 20, further comprising:
generating a hash value of the model update; and
recording the hash value and voting information associated with the votes to a blockchain.
